(19) United States
(12) Patent Application Publication
(10) Pub. No.: US 2011/0080495 A1
(43) Pub. Date: Apr. 7, 2011

(54) METHOD AND CAMERA SYSTEM FOR THE GENERATION OF IMAGES FOR THE TRANSMISSION TO AN EXTERNAL CONTROL UNIT

(75) Inventors: Erik BUSSE, Altenburg (DE); Wilhelm PRINZ VON HESSEN, Radebeul (DE)

(73) Assignee: SILICON MICRO SENSORS GMBH, Dresden (DE)

(21) Appl. No.: 12/896,219

(22) Filed: Oct. 1, 2010

(30) Foreign Application Priority Data
Oct. 1, 2009 (DE) 10 2009 043 705.3

(51) Int. Cl. H04N 5/228; G06K 9/32

(52) U.S. Cl. 348/222.1; 382/299; 348/E05.031

(57) ABSTRACT

A method and camera system are provided in which source images of a high resolution generated by an image sensor are processed by a processor in a way that, following a down-scaling of the resolution of the source image, an image copy is generated which can be transmitted to and processed in an external control unit. Additionally, a cropped image of a higher resolution in comparison to the image copy is created from the source image and also transmitted to the external control unit.

### CROSS REFERENCE TO RELATED APPLICATIONS

This application claims priority of German application number 10 2009 043 705.3 filed on Oct. 1, 2009, the entire contents of which is hereby incorporated herein by reference.

The invention relates to a method to produce images for transmission to an external control unit and a camera system used for this purpose.

### BACKGROUND OF THE INVENTION

Such camera systems, and image production and image processing procedures are used in various applications to control and regulate machines, devices or technical processes. To capture a present situation or expected situations that are predicted, an image or a sequence of several images will be taken from which the necessary information will be obtained. The image analysis is carried out by means of suitable processors which are part of electronic control units (ECU).

The ECUs are application-specific within which the software that is required for image recognition and editing is integrated so that by means of the ECU, there can eventually be responses to the gathered information. These can be very different. For instance, the output of a signal, the request for further images or the direct access to control machines, devices or processes are possible. Because the ECUs are mostly embedded in complex systems, valid standards need to be realized to ensure the compatibility of all the components of the system. In regard to camera and graphic systems, the VGA and PAL/NTSC standard are of interest here in respect to their frame rate and resolution, which is 640×480 for VGA, 720H×576V for PAL as well as 720H×480V for NTSC.

To identify the relevant information of an image, geometrical structures are to be presented in high resolution so that comparisons with known saved structures are possible, and so that recorded structures can be identified as known or unknown structures. In this case, it depends on the respective control that is to be realized whether the known or unknown structures provide the relevant information for the control. This is required for driver-assistance systems, for instance, to recognize road signs and markings as well as a vehicle driving ahead or suddenly appearing obstacles. In contrast, for example, for the safety of transporting passengers or for automated production processes, completely different structures are to be recognized and information to be processed. At the same time, there is a demand in more and more fields of applications to carry out the image analysis including the consequential responses of the control and/or regulation systems in a computerized way.

For instance in WO 01/39018 A1, a camera system with image sensor and processor to process an image as well as a method for image processing are described which serves the autonomous and computer-vision based driving support for vehicles; in that, a camera continuously records the environment, analyses the images taken and determines from this the probability and the point of time of collisions with recorded objects. In this case, the camera system distinguishes, for instance, between road markings, pedestrians, other vehicles or road signs through stored geometrical structures. To identify a point of time of collision, images are taken during the movement of the vehicle a number of times successively together with the as relevant found objects, and are suitably analysed by a processor. For that purpose, it is necessary to set the measurements of an object recorded on several successive images in relation to each other.

In regard to such and similar applications, the requirements for the sequence of images as well as for the amount of information and for the resolution of a single image are accordingly high in order to display the information needed for the respective control. For instance, for driver-support systems, it is desirable to recognise objects as far ahead as possible and at the same time beside the road with a wide aperture angle that covers the peripheral visual field.

As a result, bigger and more image sensors are used which record a closer sequence of images so that the amount of data transmitted and to be processed does not increase linearly. However, this is in contrast to the above mentioned, current valid standards for the ECUs, which restricts the to be processed resolution and image sequence.

### BRIEF SUMMARY OF THE INVENTION

A camera system and an image processing method are described through which a control unit can be provided with detailed information in a format that can be processed by the control unit.

In the camera system of the present invention, images of high resolution generated through the image sensor are possible, while images that need to be transmitted to a control unit are created with a smaller volume of data in a format that can be processed by the control unit. A minimum resolution of 1 megapixel is seen as high in comparison to the VGA standard with a resolution of 640×480 pixel that can be currently processed in such systems. The method and camera system of the present invention can also use image sensors with a considerably higher resolution of several megapixel without requiring modifications of the application-specific boards and standard ECUs, and without losing information.

According to the invention, image processing that is carried out already within the camera system and thus, independent from the ECU and not central, is possible. This way of processing images is to be differentiated from image editing that modifies the image which is carried out during or immediately after the recording by means of a suitable processor and which, for instance, is concerned with adjusting the image homogeneity with regard to the sharpness and brightness, suppressing image noise and others. This way of editing an image can take place before and complementary to the image processing of the invention, if required.

The definition of image processing, as used in this instance, can be understood as the measures that are taken on the finished image to modify it in a way that the image can be supplied to a subsequently arranged control unit. The image processing that is realized through the camera system according to the invention makes a minimising of the data traffic to the ECU possible without having to make modifications or cuts in regard to the requirements or the information therein deposited and to be tested. This is particularly beneficial as through the usually continuous monitoring with an uninterrupted image sequence, high amounts of data are already created.

Based on the specifications of the ECU, automated zooms are possible in images taken once with a real zoom-effect. The cropped image that is obtained through this shows no loss in image sharpness or other information.

Through the method to process images according to the invention, an overview image, which is designated in the following description as the image copy, is transmitted to the ECU. Although this image copy has a lower resolution in comparison to the source image taken with the high resolution image sensor, it is retrievable within the camera system with a high resolution, so that in case this image contains relevant information, in effect, a zoom in the high resolution of the source image is possible, and the cropped section of the image that is taken from the source image and also transmitted to the control unit has, once again, a resolution that is required for the ECU and which reaches the cropped image's full potential.

The creation of such an automated zoom is done by means of at least one so called regions of interest, also RoI, which are placed in regions of the shooting window in which usually relevant information are expected. In respect to driver-assistance systems, this can be, for instance, at the right top of the image border for the identification of road signs. If distances to vehicles driving in front need to be controlled, a central region would be of interest. Accordingly, the RoI are pre-determined by the user in respect to the installation location and viewing angle of the camera.

Similarly, the information identified as relevant and the resulting geometrical structures from this information, which are to be searched for in the RoI, are given by the application of the camera systems. According to the invention, these structures are however already searched for in the camera system and thus, in the high resolution image. To the ECU, then transmitted are the pre-analysed data which in comparison to the input data are considerably reduced.

The advantage of the compatibility of the pre-analysed images to the standards of the ECU as the receiver of the information can be ensured as conversions of the data formats can already take place within the camera system. Through this, a compatibility with the ECU decoupled system can be provided through which one can respond more flexibly to current developments in image recording and editing.

In addition, such an intelligence that is integrated in the camera system allows external interferences by specifically the ECU. This can be required, for instance, if because of information that was found, consecutive images are necessary through which a temporal sequence has to be monitored as, for instance, can be required for a collision warning. Such a temporal sequence of images can be realized through the ECU on one hand by continuously monitoring a RoI to determine whether an already identified object is in the RoI. On the other hand, one RoI can be continuously zoomed in to monitor it. In both cases, the transmission of zoomed cropped images of the RoI occurs in addition to the continuous stream of data going to the ECU, in the first case only if the object is identified another time, in the second case for a timely defined sequence of images.

In regard to the respective field of application of the camera system in the present invention, the images can be processed as color as well as black-and-white images. For instance, within agriculture, further information can be gained from color. However if this is not required, black-and-white images are advantageous as they provide a better resolution and transmissions which improves the recognizability of the geometrical structures and additionally, as they are easier to manage with the algorithms of the image processing.

### BRIEF DESCRIPTION OF THE DRAWINGS

FIG. 1 depicts a camera system according to the invention,

FIG. 2A depicts a source image taken by an image sensor of a camera system according to the invention,

FIG. 2B depicts an image copy of the source image of FIG. 2A,

FIG. 3A depicts a source image including the presentation of two regions of interest (RoI) and

FIG. 3B depicts a cropped image which presents one of the regions of interest of FIG. 3A.

### DETAILED DESCRIPTION OF THE INVENTION

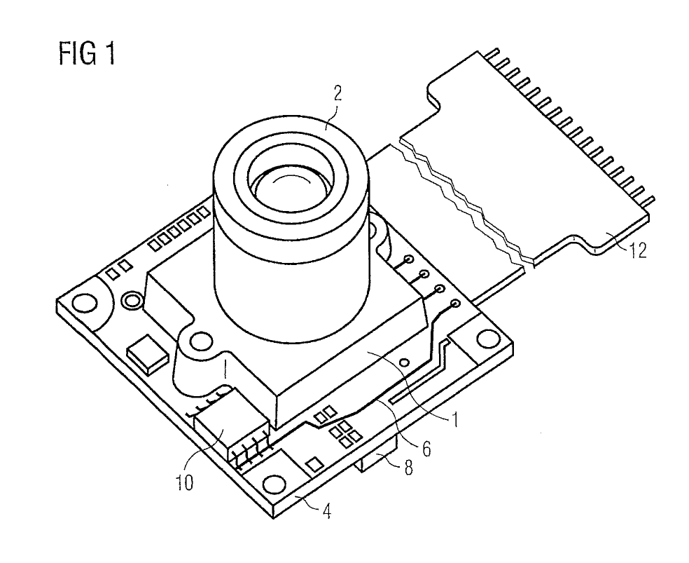

FIG. 1 shows the basic structure of a camera system according to the invention which is designed for the integration within a machine, device or monitoring method and which has a connector 12 for a connection to an electronic control unit, an ECU (not presented), in which all required monitoring and control parameters are deposited.

The camera system comprises an image sensor 1 onto which a recording optic 2 is mounted. Image sensor 1 and recording optic 2 are mounted onto a board 4 which has conductor lines 6 for electrically connecting the electronic components of the camera system. As the control for recording images and occasionally of the recording optic 2, a processor 8 is provided, which is, in this embodiment, mounted onto the rear side of board 4 which is lying opposite the image sensor 1. Further, a memory unit 10 is mounted onto board 4 which provides storage of the taken images and images that are created through the image processing. The configuration, and the cooperation of the processor 8 and the memory unit 10 results from the following description of the image processing method wherein the camera system can comprise further, standard components for the respective field of application or for the image editing.

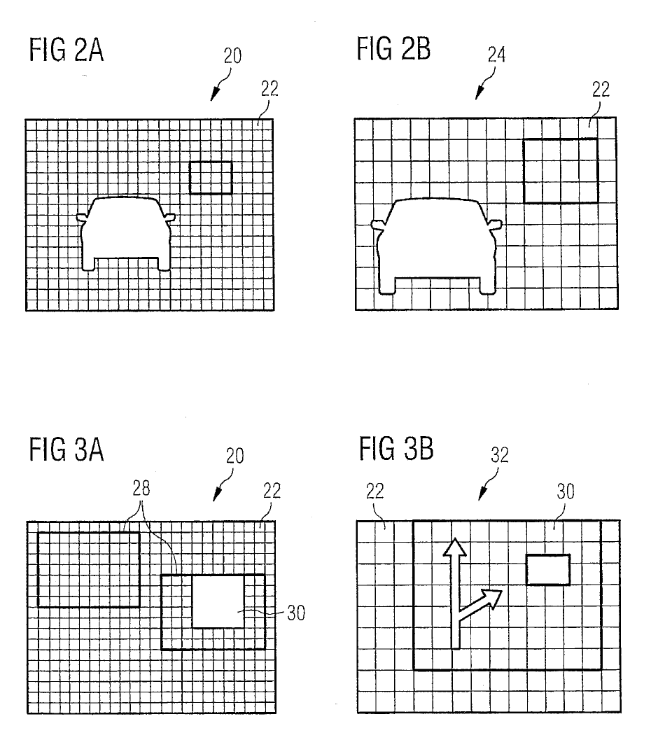

FIG. 2A exhibits a source image 20 which is taken by means of the image sensor 2 and stored in the memory unit 10. The resolution of the source image 20 is presented schematically in form of a grid. The grid's dimensions and thus, the image resolution is presented here, however, only relative to the other Figures and should not be taken as absolute so that a denser grid in FIG. 2A shall present the high resolution source image 20 of, for instance, 1.3 megapixels. One square of the grid represents one pixel 22.

With the help of the processor 8, an image copy 24 of the source image 20 is created (FIG. 2B) and also stored in the memory unit 10. The generation of the image copy 24 is done by combining several adjacent, for instance, four pixels 22 that form one square, as one macro pixel 26, and this is carried out for the entire source image 20 so that the resolution of the image copy 24 is one fourth of that relative to the source image 20. The scaling factor of the resolution is ¼. The scaling factor is determined by the amount of pixels of the source image 20 and the standard of resolution of the control unit (not presented) to which the resolution of the source image shall be reduced. The image copy 24 is transmitted via the connector 12 to a not presented control unit.

Before scaling down the resolution, the unsealed source image 20 is checked for pre-defined geometrical structures that are defined by the user and stored in the memory unit 10. This check takes place in selected regions of the source image 20 in which the respective geometrical structures 30 are usually expected. The regions are designated as regions of interest 28 or RoI. In the source image 20, for instance, there are two RoI 28 presented (FIG. 3A). In one of them, a geometrical structure 30 is identified, for instance, a rectangular road sign.

Of the RoI 28 that shows a geometrical structure 30, a cropped image 32 (FIG. 3B) is created by the processor 8 originating from the unsealed source image 20, that is only a little or not scaled, in this embodiment it is the latter, so that it is adapted to the standard of the resolution of the control unit but still presents sufficiently detailed image information to be useable for a further analysis within the control unit. The pixels 22 of the image part 32 are therefore consistent with the pixels 22 of the source image 20.

To be able to extract optimal image information from the cropped image 32, it is beneficial to transmit the cropped image 32 unsealed. In this case, the amount of pixels and thus, the size of the RoI 28 result from the resolution standard of the control unit multiplied by the reciprocal scaling factor. If the RoI 28 comprises more pixels 22, a down-scaling is required for the adjustment to the standard as well as for creating the cropped image 32. The down-scaling however should be as close as possible to one as the greatest possible amount of information can be provided to the control unit in this way. Within the defined size, one or more RoI 28 can be placed on the source image 20.

Although the description occurred in reference to a camera system which is used for driver support in road traffic, no restrictions are therefore intended on the normally to be processed image information in such a case and on resulting special algorithms. In a similar way, the camera system, and the image recording and image processing methods can be used for different areas as well as for mobile and for stationary camera systems.

1. Method for generating images and their transmission to an external control unit, comprising:
recording a first source image of a high resolution determined by an image sensor that serves to record the image,
generating an image copy of the source image by a processor, wherein the image copy comprises macro pixels of down scaled resolution in comparison to the source image, and every macro pixel is created by combining a pre-defined amount of adjacent pixels of the source image so that the number of pixels per macro pixel describes a scaling factor,
comparing a pre-defined region of interest of the source image, with at least one stored geometrical structure,
creating a cropped image of the region of interest of the source image, when the region of interest contains said geometrical structure, and
transmitting the image copy and the cropped image, as long as these images are created beforehand, to the external control unit.

2. Method according to claim 1, wherein the resolution of the image copy and/or of the cropped image meet a standard of a graphic card.

3. Method according to claim 1, wherein the cropped image is unsealed.

4. Method according to claim 1, wherein the external control unit initiates recording of at least one more source image which shows content of the first source image at a later time, and the region of interest in the at least one more source image is examined for said geometrical structure for a possible creation of another cropped image.

5. Method according to claim 1, wherein the external control unit initiates transmission of at least one more cropped image of a region of interest of a second source image recorded at a later time irrespective of whether said geometrical structure was found in the region of interest or not.

6. Method according to claim 1, wherein the region of interest is determined by location of the region relative to borders of the source image and size of the region.

7. Method according to claim 1, wherein the source image is recorded in black and white.

8. Camera system for generation of images for transmission to an external control unit, comprising:
an image sensor for recording of images,
a memory unit for storage of image information and geometrical structures,
a connector, configured to connect to an external control unit and transmission of image information to the control unit,
a processor for processing a recorded source image, wherein the processor is configured to carry out a down scaling of resolution of the source image by combining several adjacent pixels to one macro pixel, and in this way create an image copy which consists of macro pixels,
wherein the processor is further configured to compare content of a pre-defined region of interest of the source image with at least one of the geometrical structures stored in the memory unit, and create a cropped image of the region of interest when this geometrical structure is found, and
wherein the processor is further configured to transmit the image copy and cropped image to the external control unit.

9. Camera system according to claim 8, wherein the image copy and/or the cropped image has a resolution that meets a standard of a graphic card.

10. Camera system according to claim 8, wherein the processor is further configured to receive an external signal which initiates recording of a source image and/or creation of a cropped image of a previously taken source image and/or a source image stored in the memory unit.

11. Camera system according to claim 8, wherein the image sensor has a resolution of 1 mega pixel or more.
